(19) United States
(12) Patent Application Publication
(10) Pub. No.: US 2010/0306794 A1
(43) Pub. Date: Dec. 2, 2010

(54) METHOD AND DEVICE FOR CHANNEL MANAGEMENT

(75) Inventors: Houng-Jyh Wang, Taipei City (TW); Ting-Chang Wu, Taipei City (TW); Yao-Ching Huang, Taipei County (TW); Jian-Yu Ha, Taichung County (TW)

Correspondence Address: RABIN & Berdo, PC, 1101 14TH STREET, NW, SUITE 500, WASHINGTON, DC, 20005, US

(73) Assignee: TECO ELECTRIC & MACHINERY CO., LTD., Taipei (TW)

(21) Appl. No.: 12/611,980

(22) Filed: Nov. 4, 2009

(30) Foreign Application Priority Data
May 27, 2009 (TW) 098117676

(51) Int. Cl. H04N 7/16; H04N 7/173

(52) U.S. Cl. 725/27; 725/118

(57) ABSTRACT

A channel management method is provided for use in a channel management device. The channel management method includes the following steps. First, a scan request is received. Also, a number of television channels are scanned to generate a first set of channel list. Next, a number of network channels are scanned to generate a second set of channel list. Then, an integrated channel list is generated according to at least one set of channel lists which at least includes the first and the second set of channel lists. Afterwards, the content of a corresponding program is provided according to the integrated channel list and a selected channel thereof, when the selected channel is selected.

This application claims the benefit of Taiwan application Serial No. 98117676, filed May 27, 2009, the subject matter of which is incorporated herein by reference.

### BACKGROUND OF THE DISCLOSURE

1. Technical Field

The disclosure relates in general to a channel management method and a channel management device, and more particularly to a channel management method and a channel management device for integrating a number of television channels and a number of network channels.

2. Description of the Related Art

Internet Protocol Television (IPTV) is a system through which digital television service is delivered based on the architecture and networking methods of the Internet Protocol Suite. Regarding a television as a personal computer or a terminal device, IPTV provides its clients a variety of services such as digital television broadcast, video servicing, information servicing, interactive community, interactive entertainment, or electronic commerce. Moreover, with the rapid growth of accessible information and the popularization made in international network, versatile and diverse multimedia files are available over a network. As such, by using IPTV, corresponding programs of the multimedia files can be displayed for users.

In general, when a user is operating IPTV, he or she usually tends to select programs by using a mouse of a computer, e.g. he or she can use the mouse to switch channels. On the other hand, operation for a conventional television is usually completed by a remote controller which transmits signals for channel selection. The way of operating IPTV by using the mouse is different from that of operating a conventional television by using the remote controller, thereby causing inconvenience for the user.

### SUMMARY OF THE DISCLOSURE

The disclosure is directed to a channel management method and a channel management device, in which an integrated channel list is generated according to at least two sets of channel list which are obtained by scanning a number of television channels and network channels, and the channel information in the integrated channel list is searched for providing the content of a corresponding program of a selected channel. In this way, the present embodiment allows a user to select a desired channel from the television channels and network channels in the same manner, thereby increasing the convenience for the user.

According to a first aspect of the present disclosure, a channel management method is provided for use in a channel management device. The channel management method includes the following steps. First, a scan request is received. Then, a number of television channels are scanned to generate a first set of channel list. Also, a number of network channels are scanned to generate a second set of channel list. Then, an integrated channel list is generated according to at least one set of channel lists which at least includes the first and the second set of channel lists. Afterwards, the content of a corresponding program is provided according to the integrated channel list and a selected channel thereof, when the selected channel is selected.

According to a second aspect of the present disclosure, a channel management device is provided. The channel management device includes a receiver unit, a first scan unit, a second scan unit, a channel integration unit, a storage unit, and a play unit. The receiver unit is for receiving a scan request. The first scan unit is connected to the receiver unit, for generating a first set of channel list by scanning a number of television channels in response to the scan request. The second scan unit is connected to the receiver unit, for generating a second set of channel list by scanning a number of network channels in response to the scan request. The channel integration unit is connected to the first scan unit and the second scan unit, for generating an integrated channel list according to at least one set of channel list which at least includes the first and the second set of channel lists. The storage unit is for storing the integrated channel list. The play unit is connected to the receiver unit and the storage unit, for providing, when a channel is selected, content of a corresponding program according to the integrated channel list and the selected channel.

The disclosure will become apparent from the following detailed description of the preferred but non-limiting embodiments. The following description is made with reference to the accompanying drawings.

### BRIEF DESCRIPTION OF THE DRAWINGS

FIG. 1 is a flowchart showing a channel management method according to an embodiment of the invention.

FIG. 2 is a block diagram showing a channel management device according to an embodiment of the invention.

FIG. 3 is a schematic diagram showing an example of the integrated channel list which is generated by the channel integration unit according to at least one set of channel list.

FIG. 4 is a block diagram showing an example of the practical architecture for the channel management device according to an embodiment of the invention.

### DETAILED DESCRIPTION OF THE DISCLOSURE

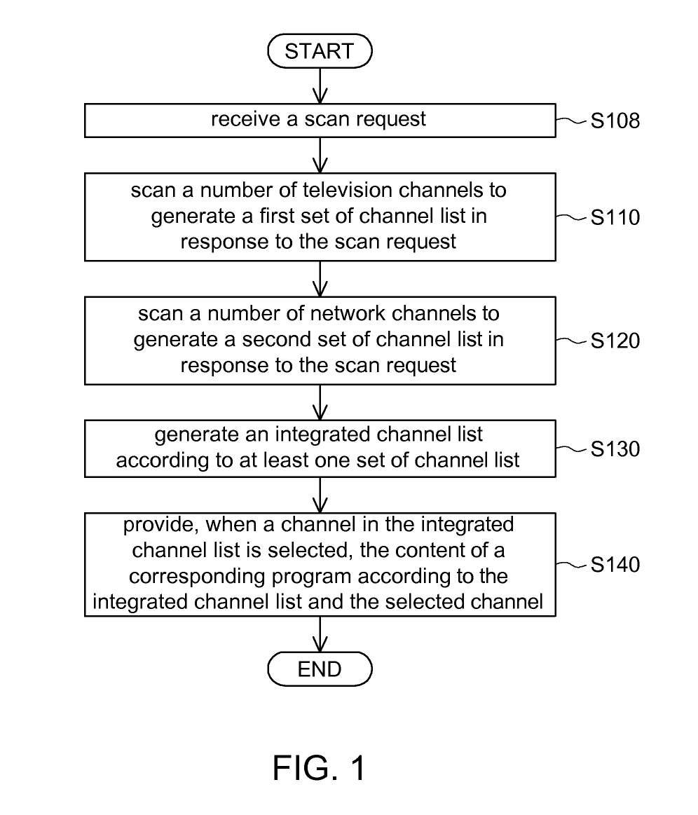

FIG. 1 is a flowchart showing a channel management method according to an embodiment of the invention. The channel management method is for use in a channel management device, which includes a number of exemplary steps as follows.

First, as shown in step S108, a scan request is received. Then, as shown in step S110, a first set of channel list is generated by scanning a number of television channels. Also, as shown in step S120, a second set of channel list is generated by scanning a number of network channels.

Next, as shown in step S130, an integrated channel list is generated according to at least one set of channel list which at least includes the first and the second set of channel lists. After that, when a channel is selected, content of a corresponding program is provided according to the integrated channel list and the selected channel.

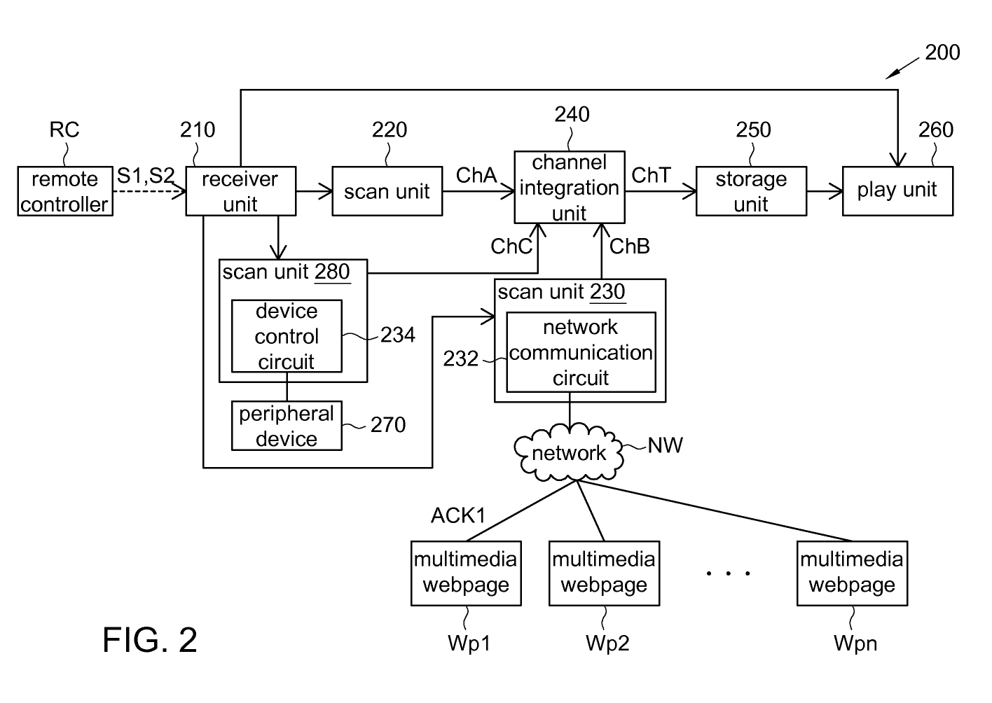

A channel management device which applies the network-based multimedia play method in FIG. 1 is elaborated below for further illustration. FIG. 2 is a block diagram showing a channel management device according to an embodiment of the invention. The channel management device 200 includes a receiver unit 210, two scan units 220 and 230, a channel integration unit 240, a storage unit 250, and a play unit 260.

The receiver unit 210 receives a scan request S1. The scan request S1 is received, for example, when the channel management device 200 is initialized, which requests the channel management device 200 to perform a scan function for searching channels. When receiving the scan request S1, the channel management device 200 starts to scan channels, so as to search for valid television channels or network channels. Searching for valid television channels or network channels means that the channel management device 200 detects the existence of television signals or network signals which are in compliance with requirements. The television signals can be, for example, cable transmission signals, or wireless transmission signals such as terrestrial and satellite transmission signals. The network signals can be, for example, signals for data interchange which a computer uses to be linkup with webpages over a network NW and to access data therefrom.

The receiver unit 210 can further receive a channel selection request S2, which requests the channel management device 200 to select a channel from a channel list, and to play the program content of the selected channel, allowing a user to watch the program. The mentioned scan request S1 and the channel selection request S2 can be, for example but non-limitedly, transmitted from a remote controller RC. The receiver unit 210 can, for example, include a sensor, such as an infrared sensor (not shown), for receiving and identifying, from the remote controller RC, the request signals such as the mentioned scan request S1 and the channel selection request S2.

The scan unit 220 is connected to the receiver unit 210, for generating a first set of channel list ChA by scanning a number of television channels in response to the scan request S1. The scan unit 220 can, for example, scan a number of analog television channels or digital television channels. As in an embodiment of the scan unit 220, it can include a number of circuit elements, such as a tuner, a demodulator, and a demultiplexer (not shown), and can execute a scan program to control these circuit elements, so as to perform the scan function for searching channels. However, the present embodiment is not limited thereto. In order to scan the analog television channels or digital television channels, the scan unit 220 and its embodied circuit elements can have different implementation according to different kinds of television signal thereof.

When scanning the television channels, the scan unit 220 can, for example, detect whether there are television signals within a certain frequency range. If there are television signals within the certain frequency range, the scan unit 220 determines that a corresponding channel of the frequency range is valid. Thereafter, the scan unit 220 determines channel numbers for each of the valid television channels according to their frequency ranges. In this way, after scanning a number of television channels, the scan unit 220 can generate a first set of channel list ChA accordingly which establishes a relationship between channel numbers of the television channels and a number of demodulation frequencies.

The scan unit 230 is connected to the receiver unit 210, for generating a second set of channel list ChB by scanning a number of network channels in response to the scan request S1. In FIG. 2, the scan unit 230 includes, for example, a network communication circuit 232, for being connected to a network NW. When generating the second set of channel list ChB by scanning the network channels, the scan unit 230 can, for example, control the network communication circuit 232 to sequentially detect whether a number of multimedia webpages Wp1 to Wpn are accessible.

For example, detecting whether the multimedia webpages Wp1 to Wpn are accessible can be embodied as follows. The scan unit 230 can obtain an address of a multimedia webpage, such as the multimedia webpage Wp1, from another storage unit 280 (now shown in FIG. 2), and uses a network test command, such as a command of “ping”, to test the accessibility for the address. At this time, if the scan unit 230 receives a corresponding response signal ACK1, it may indicate that the multimedia webpage Wp1 is accessible. On the other hand, if the response signal ACK1 is not received within a predetermined time period, it may indicate that multimedia webpage is inaccessible. However, this invention is not limited thereto. Any approach capable of detecting whether the multimedia webpages Wp1 to Wpn are accessible is regarded as a practicable implementation of the scan unit 230.

In an embodiment, if an accessible multimedia webpage is detected in the course of generating the second set of channel list ChB, the scan unit 230 generates a corresponding play list of a network channel according to the accessible multimedia webpage.

For example, if the scan unit 230 detects an accessible multimedia webpage Wp1, the scan unit 230 generates the play list in a manner illustrated below. The scan unit 230 controls the network communication circuit 232 to obtain a source code of the multimedia webpage Wp1. Then, the scan unit 230 parses the source code to obtain a number of program titles and a number of corresponding program website addresses. After that, the scan unit 230 further obtains at least one file link according to each program website address, wherein each file link is an access link of a multimedia file. Next, according to each program title and the at least one corresponding file link of each program title, the scan unit 230 generates a corresponding play list of a network channel.

Such a manner of generating the play list mentioned above is provided for elaborating the invention only. It is believed that the scan unit 230 can be embodied as one capable of obtaining the file links of multimedia files from the multimedia webpages, and thus generating the playlist. In this way, according to the multimedia webpages Wp1 to Wpn, the scan unit 230 can generate a number of play lists correspondingly, and correlates the play lists with a number of network channel numbers sequentially, so as to generate the second set of channel list ChB. In other words, the second set of channel list ChB establishes a relationship between channel numbers of the network channels and the play lists generated from the multimedia webpages.

The channel integration unit 240 is connected to the second scan units 220 and 230, for generating an integrated channel list ChT according to at least one set of channel list. The at least one set of channel list at least includes the first set of channel lists ChA and the second set of channel list ChB. As shown in FIG. 2, the integrated channel list ChT is, for example, stored in the storage unit 250.

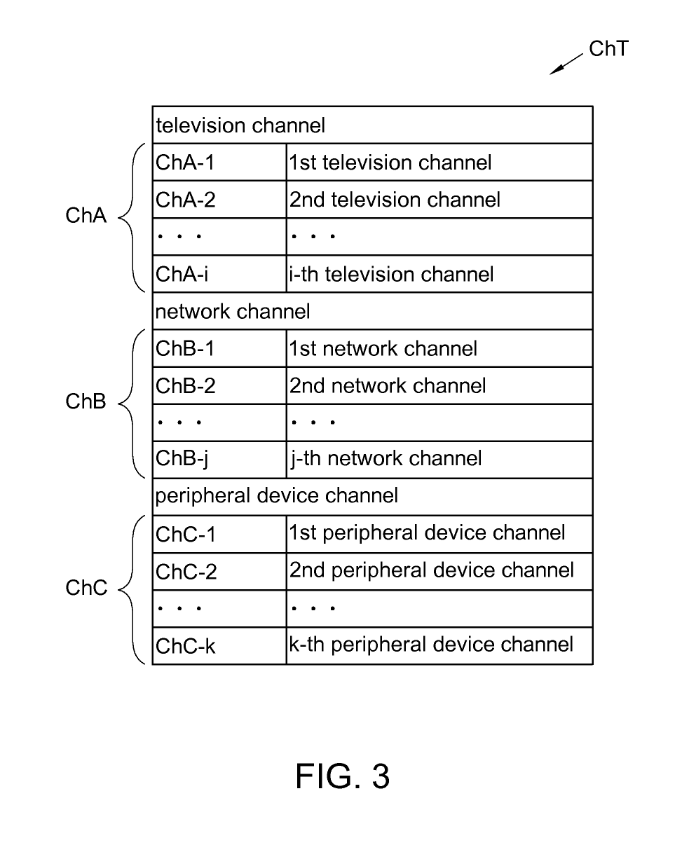

In the course of generating the integrated channel list, the channel integration unit 240 can, for example, arrange the channels of every set of channel list in order according to their channel numbers, establishing an ordering relationship between the channels and their channel numbers for every set of channel list. Specifically, an example is shown in FIG. 3, which is a schematic diagram showing an example of the integrated channel list which is generated by the channel integration unit according to at least one set of channel list. In this example, the first set of channel list ChA includes i channels ChA-1 to ChA-i, and the second set of channel list ChB includes j channels ChB-1 to ChB-j. The channels and corresponding channel numbers in the two sets of channel list ChA and ChB are arranged in order.

As for the example shown in FIG. 3, assume that the numbers of channels ChA-1 to ChA-i are less than that of the channels ChB-1 to ChB-j. In this case, according to the channel numbers thereof, the channel integration unit 240 generates an integrated channel list ChT in which the second set of channel list ChB follows the first set of channel list ChA. As such, the channel numbers in the two sets of channel list ChA and ChB can thus be arranged in order. Therefore, the channel integration unit 240 can integrate the two sets of channel list ChA and ChB into the integrated channel list CHT. At this time, for a current channel which is selected as a television channel ChA-i in the first set of channel list ChA, if the channel selection request S2 is requested a switching of a next channel, the channel being selected subsequently will be a network channel ChB-1 in the second set of channel list ChB. Accordingly, a switching of a previous channel is functioning in a similar manner.

Referring to FIG. 2, the play unit 260 is connected to the receiver unit 210 and the storage unit 250, for selecting a selected channel in the integrated channel list ChT. When a channel is selected, the play unit 260 provides content of a corresponding program according to the integrated channel list ChT and the selected channel.

As in an example, if the selected channel is the one in the first set of channel list ChA, the play unit 260 selects a corresponding demodulation frequency of the selected channel number from the integrated channel list ChT. Then, the play unit 260 uses the selected demodulation frequency to receive television signals for playing television programs.

As in another example, if the selected channel is the one in the second set of channel list ChB, the play unit 260 selects a corresponding play list of the selected channel number from the integrated channel list ChT. Then, the play unit 260 uses the selected play list to determine how to play multimedia files listed on the play list.

According to the integrated channel list ChT, when receiving a channel selection request S2 for selecting a channel, the receiver unit 210 can play program content of a television channel or a network channel correspondingly. As compared with a conventional way of operating IPTV by using, for example, a mouse, which is different from that of a television, the present embodiment allows a user to select a desired channel from the television channels and network channels in the same manner, such as a manner of using the remote controller RC to transmit the channel selection request S2. Therefore, the present embodiment is capable of increasing the convenience for the user.

Besides, refer to FIG. 2 for further illustration. In another embodiment, the scan unit 230 can, for example, further include another scan unit 280. The scan unit 280 includes a device control circuit 234, for being connected to a peripheral device 270. The peripheral device 270 includes a device complied with a protocol based on universal serial bus (USB), such as a USB device.

In this embodiment, the scan unit 280 further detects whether the device control circuit 234 is connected to the peripheral device 270. If the device control circuit 234 is connected to the peripheral device 270, the third scan unit 270 further generates a third set of channel list ChC by scanning files stored in the peripheral device 270. The files stored in the peripheral device 270 can, for example, include a number of multimedia files. As such, when the scan unit 280 scans the files stored in the peripheral device 270, it detects the file formats of the stored multimedia files to generate the third set of channel list ChC.

As shown in FIG. 3, after detecting the file formats of the stored multimedia files, the scan unit 280 can generate k channels ChC-1 to ChC-k correspondingly, allowing them to be selected. At this time, if the selected channel is the one in the third set of channel list ChC, the play unit 260 selects, from the integrated channel list ChT, a corresponding file format of the selected channel number for the k channels ChC-1 to ChC-k. Then, the play unit 260 determines how to play multimedia files stored in the peripheral device 270.

For example, the scan unit 280 can detect whether the file format belongs to one of a picture format, a music format, and a video format for each of the multimedia files. In this regard, after the detection the file format of each the multimedia file, such as the detection of the mentioned picture format, music format, and video format, the k channels ChC-1 to ChC-k are presented as three channels to be selected. In practice, the three channel titles for the third set of channel list ChC can be, for example, set as a USB video channel, a USB music channel, and a USB gallery channel, and they are corresponding to channel numbers ChC-1 to ChC-3, respectively. In this way, if the selected channel is the USB video channel, the play unit 260 will play the stored multimedia files in the peripheral device 270 file formats of which belong to video format.

Moreover, in a similar manner of integrating the first and the second sets of channel list ChA and ChB, the channel integration unit 240 can further make use of the first to the third set of channel list ChC to generate the integrated channel ChT. For example, the channel integration unit 240 generates the integrated channel list ChT in which the third set of channel list ChC follows the second set of channel list ChB. As such, the channel numbers in the two sets of channel list ChB and ChC can thus be arranged in order, which is shown in FIG. 3. However, the invention is not limited thereto. The ordering relationship between the three sets of channel list ChA, ChB, and ChC can be arranged with respect to their channel numbers, or can be arranged under user requirements.

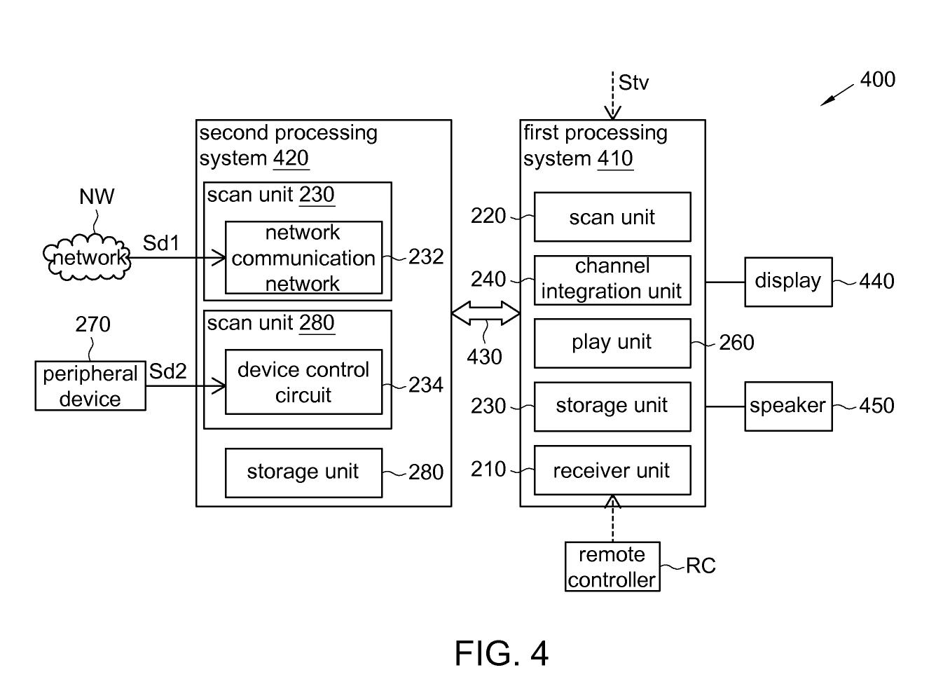

FIG. 4 is a block diagram showing an example of the practical architecture for the channel management device according to an embodiment of the invention. As shown in FIG. 4, the channel management device 400 includes a first processing system 410, a second processing system 420, a signal transmission unit 430, a display 440, and a speaker 450.

The first processing system 410 is, for example, an analog signal processing system for processing an analog television signal Stv. As shown in FIG. 4, in the exemplary architecture of the channel management device 400, the receiver unit 210, the scan unit 220, the channel integration unit 240, the storage unit 250, and the play unit 260 are implemented by the first processing system 410

The second processing system 420 is, for example, a digital signal processing system for processing digital signals Sd1 and Sd2 transmitted from the network NW and the peripheral device 270. As shown in FIG. 4, in the exemplary architecture of the channel management device 400, the scan unit 230, the scan unit 280, and the storage unit 280 are implemented by the second processing system 420. Besides, in an embodiment, the two scan units 230 and 280 can be implemented as one scan unit with both of their functions, which can scan a number of network channels over a network NW and scan the stored files in the peripheral device 270.

In practice, the first processing system 410 can include, for example, a master processor, and the second processing system 420 can include, for example, a slave processor. The mater processor and the slave processor carry out signal transmission through the mentioned signal transmission unit 430.

The signal transmission unit 430 is connected to the first processing system 410 and the second processing system 420, for transmitting signals between the first processing system 410 and the second processing system 420. The signal transmission unit 430 can be, for example, implemented by an interface based on universal asynchronous receiver/transmitter (UART), or other signal transmission interface. The signals transmitted between the two processing systems 410 and 420 include, for example, video/audio signals, power signals, and control signals.

The display 440 and the speaker 450 can be, for example, connected to the first processing system 410. The display 440 and the speaker 450 provide images and sounds when the play unit 260 is playing the program content, allowing a user to watch the program.

As for the channel management device 400, it can be implemented by the two processing systems 410 and 420 for illustration. However, the invention is not limited thereto. In a practical application, one should be able to integrate the two processing systems 410 and 420 into a main system capable of processing digital signals and analog signals, which is also regarded as an alternate implementation for the channel management device.

According to the channel management method and the channel management device disclosed in the present embodiments of the invention, an integrated channel list is generated according to at least two sets of channel list which are obtained by scanning a number of television channels and network channels, and the channel information in the integrated channel list is searched for providing the content of a corresponding program of a selected channel. In this way, the present embodiment allows a user to select a desired channel from the television channels and network channels in the same manner, thereby increasing the convenience for the user.

While the disclosure has been described by way of example and in terms of a preferred embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A channel management device, comprising:
a receiver unit for receiving a scan request;
a first scan unit, connected to the receiver unit, for generating a first set of channel list by scanning a number of television channels in response to the scan request;
a second scan unit, connected to the receiver unit, for generating a second set of channel list by scanning a number of network channels in response to the scan request;
a channel integration unit, connected to the first scan unit and the second scan unit, for generating an integrated channel list according to at least one set of channel list which at least includes the first and the second set of channel lists;
a storage unit for storing the integrated channel list; and
a play unit, connected to the receiver unit and the storage unit, for providing, when a channel is selected, content of a corresponding program according to the integrated channel list and the selected channel.

2. The channel management device according to claim 1, wherein the second scan unit comprises:
a network communication network, for being connected to a network;
wherein when the second scan unit generates the second set of channel list by scanning the network channels, the second scan unit controls the network communication network to sequentially detect whether a plurality of multimedia webpages are accessible.

3. The channel management device according to claim 2, wherein, if the second scan unit detects that a multimedia webpage is accessible, when the second scan unit generates the second set of channel list by scanning the webpages, the second scan unit controls the network communication circuit to obtain a webpage source code of the multimedia webpage,
wherein, the second scan unit further parses the webpage source code to obtain a number of program titles and a number of corresponding program website addresses;
wherein, the second scan unit further obtains at least one file link for each program website address, each file line being a access link for a multimedia file;
wherein, the second scan unit further establishes a corresponding play list for the website channel according to each program title and the corresponding at least one file link;
wherein, the second set of channel list establishes a relationship between channel numbers of the network channels and the play lists.

4. The channel management device according to claim 3, wherein if the selected channel is in the channels of the second set of channel list, when the play unit provides the content of a corresponding program according to the integrated channel list and the selected channel, the play unit selects a corresponding play list from the integrated channel list for the selected channel, and determines how to play the multimedia files according to the selected play list.

5. The channel management device according to claim 1, further comprises a third scan unit comprising:
a device control circuit, for being connected to a peripheral device;
wherein, the third scan unit is further for detecting whether the device control circuit is connected to the peripheral device;
wherein, if the device control circuit is connected to the peripheral device, the third scan unit is further for generating a third set of channel list by scanning files stored in the peripheral device;
wherein, the at least one set of channel list further includes the third channel list.

6. The channel management device according to claim 5, wherein the files stored in the peripheral device comprise a plurality of multimedia files, and when the third scan unit scans the files stored in the peripheral device, the third scan unit detects the file formats of the multimedia files to generate the third set of channel list.

7. The channel management device according to claim 6, wherein the third scan unit detects whether the file format belongs to one of a picture format, a music format, and a video format for each of the multimedia files.

8. The channel management device according to claim 5, wherein the peripheral device comprises a device complied with a protocol based on universal serial bus (USB).

9. The channel management device according to claim 5, wherein the receiver unit, the first scan unit, the channel integration unit, the storage unit, and the play list are implemented in a first processing system, and the second scan unit and the third scan unit are implemented in a second processing system.

10. The channel management device according to claim 7, further comprises:
a signal transmission unit, connected to the first processing system and the second processing system, for transmitting signals between the first processing system and the second processing system.

11. The channel management device according to claim 9, wherein the first processing system comprises a master processor, and the second processing system comprises a slave processor.

12. The channel management device according to claim 1, wherein the channel integration unit generates the integrated channel list according to the order of channels numbers of the at least one set of channel list.

13. A channel management method for use in a channel management device, comprising the steps of:
receiving a scan request;
generating a first set of channel list by scanning a number of television channels;
generating a second set of channel list by scanning a number of network channels;
generating an integrated channel list according to at least one set of channel list which at least includes the first and the second set of channel lists; and
providing, when a channel is selected, content of a corresponding program according to the integrated channel list and the selected channel.

14. The channel management method according to claim 13, further comprising, before the step of generating the second set of channel list by scanning the network channels, the step of:
detecting whether a plurality of multimedia webpages are accessible,
wherein, if the second scan unit detects that a multimedia webpage is accessible, the step of generating the second set of channel list by scanning the network channels comprises:
obtaining a webpage source code of the multimedia webpage;
parsing the webpage source code to obtain a number of program titles and a number of corresponding program website addresses;
obtaining at least one file link for each program website address, each file line being a access link for a multimedia file;
establishing a corresponding play list for the website channel according to each program title and the corresponding at least one file link;
wherein, the second set of channel list establishes a relationship between channel numbers of the network channels and the play lists.

15. The channel management method according to claim 14, wherein if the selected channel is in the channels of the second set of channel list, the step of providing the content of a corresponding program according to the integrated channel list and the selected channel comprises:
selecting a corresponding play list from the integrated channel list for the selected channel; and
determining how to play the multimedia files according to the selected play list.

16. The channel management device according to claim 13, further comprising:
detecting whether the device control circuit is connected to a peripheral device; and
generating, if the device control circuit is connected to the peripheral device, a third set of channel list by scanning files stored in the peripheral device;
wherein, the at least one set of channel list further includes the third channel list.

17. The channel management device according to claim 16, wherein the files stored in the peripheral device comprise a plurality of multimedia files, and the step of generating the third channel list by scanning the stored files in the peripheral device is performed according to the file formats of the multimedia files.

18. The channel management device according to claim 17, wherein the file formats of the multimedia files include at least one of a picture format, a music format, and a video format.

19. The channel management device according to claim 16, wherein the peripheral device comprises a device complied with a protocol based on universal serial bus (USB).

20. The channel management device according to claim 13, wherein, in the step of generating the integrated channel list according to at least one set of channel list, the integrated channel list is generated according to the order of channel numbers of the at least one set of channel list.
